(19) United States
(12) Patent Application Publication
(10) Pub. No.: US 2019/0107702 A1
(43) Pub. Date: Apr. 11, 2019

(54) MICROSCOPE AND METHOD FOR PRODUCING A MICROSCOPIC IMAGE WITH EXPANDED DEPTH OF FIELD

(71) Applicant: CARL ZEISS MICROSCOPY GMBH, Jena (DE)

(72) Inventors: Alexander GAIDUK, Jena (DE); Rohith KUMAR, Jena (DE); Pavlos ILIOPOULOS, Weimar (DE); Stanislav KALININ, Weimar (DE)

(21) Appl. No.: 16/156,966

(22) Filed: Oct. 10, 2018

(30) Foreign Application Priority Data
Oct. 10, 2017 (DE) 10 2017 123 511.6

(51) Int. Cl. G02B 21/24; G02B 21/36

(52) U.S. Cl. CPC G02B 21/244; G02B 21/367

(57) ABSTRACT

The present invention relates firstly to a method for producing a microscopic image with an extended depth of field by means of a microscope. In a step of the method, a plurality of microscopic frames of a specimen are acquired from different focus positions, for example with different dimensions of a distance between the specimen and an objective lens of the microscope. In another step, the plurality of microscopic frames are processed so as to form a microscopic image with an extended depth of field. According to the invention, the focus position is continuously changed during the acquisition of at least some of the microscopic frames at a variable speed or with variable acceleration. The invention further relates to a microscope with an objective lens for optically imaging a specimen.

### FIELD

The present invention relates firstly to a method for producing a microscopic image with an extended depth of field by means of a microscope. The invention further relates to a microscope with an objective lens for optically imaging a specimen.

### BACKGROUND

DE 10 2014 006 717 A1 describes a method for generating three-dimensional information for an object in a digital microscope. In this method, an image is taken for each focus position and stored with the associated focus position in an image stack. An image with an extended depth of field—a so-called EDoF image—is produced by calculation from the acquired images of the image stack. During the process of calculating the EDoF image, a number of pixel defects are detected, which are corrected by interpolation with neighboring pixels. The corrected EDoF image is used to calculate a height map or 3D model of the object.

US 2014/0185462 A1 discloses a microscope with a first motorized drive in the z-direction for positioning a unit comprising an objective lens and a camera and with a second motorized drive in the z-direction for positioning a specimen stage for receiving a specimen. The first motorized drive enables images with an extended depth of field to be acquired.

U.S. Pat. No. 8,581,996 B2 discloses an imaging device with which large areas of a specimen can be acquired and digitized and images with an extended depth of field can be outputted. The imaging device comprises a movable specimen stage for receiving the specimen and a unit for changing the focus position. The imaging device further comprises inter alia a camera and a unit for generating the images with an extended depth of field. The images with extended depth of field are omnifocal images.

US 2015/0185465 A1 teaches a digital microscope for acquiring and generating images with an extended depth of field. The microscope is configured to perform asynchronous and parallel positioning in the z-direction, image acquisition, and image processing in order to enable images with an extended depth of field to be acquired and produced more quickly.

In US 2015/0185464 A1, a solution is described that is aimed at saving time in the investigation of a field of view. To achieve this, the magnification factor of an objective lens and the positioning in the z-direction, among other things, are adjusted.

Digital microscopes of types VHX2000 and VHX5000 from the manufacturer Keyence enable microscopic images with an extended depth of field to be acquired. The VHX5000 digital microscope manufactured by Keyence enables the topology of a specimen measuring approximately 138 μm in height to be acquired by means of a stack of 12 images in a period of about 9 seconds.

The SmartZoom5 microscope from the manufacturer Carl Zeiss Microscopy GmbH enables the microscopic image of a specimen with a height of 10 mm to be acquired by means of an image stack with about 60 images in about 25 seconds, with a subsequent calculation of a microscopic image with an extended depth of field taking about 19 seconds. It thus takes about 44 seconds in total to provide the image with extended depth of field.

In taking the prior art as a point of departure, it is the object of the present invention to enable microscopic images having an extended depth of field to be produced more quickly and/or with greater quality. Such generation requires the acquisition and processing of the microscopic frames.

### SUMMARY

This object is achieved by a method according to enclosed claim 1 as well as by a microscope according to enclosed subsidiary claim 10.

The method according to the invention is used to generate a microscopic image with an extended depth of field (EDoF), which is also referred to as an EDoF image. For this purpose, a microscope is used which is particularly a digital microscope. The microscope comprises an objective lens and an image sensor for converting an image reflected directly or indirectly from the objective lens onto the image sensor.

In one step of the method according to the invention, a plurality of microscopic frames of a specimen are acquired with the microscope. The microscopic frames are acquired from different focus positions, so that each of the individual regions of the specimen are sharply imaged in at least one of the microscopic frames. The different focus positions are especially preferably achieved through varying actuation of a microsystem with movable mirrors. As a preferred alternative, the different focus positions are achieved through varying actuation of a deformable optical lens. As a preferred alternative, the different focus positions are formed by varying a distance between the specimen and the objective lens of the microscope. The distance between the specimen and the objective lens of the microscope can also be described as the z-coordinate. The microscopic frames form a stack. The images of the stack differ from one another by the z coordinate of their acquisition, so that they can also be referred to as z-stacks.

In another step of the method according to the invention, the acquired plurality of microscopic frames are processed so as to form microscopic image with an extended depth of field. For this purpose, insofar as possible, only sharply imaged regions from the individual acquired microscopic frames are used in order to produce, by calculation, the microscopic image with an extended depth of field. The microscopic image to be calculated reproduces the specimen with an extended depth of field.

According to the invention, the focus position is continuously changed during the acquisition of at least some of the microscopic frames. The focus position is thus continuously changed during the acquisition of the microscopic frames at a variable speed and/or with variable acceleration, so that at least several of the microscopic frames having a constant focus position are not excluded, but rather areas of each frame are acquired from different focus positions. Preferably, the focus position is changed continuously during the acquisition of all of the microscopic frames. Preferably, the speed and/or the acceleration is changed over the course of acquiring the respective microscopic frames.

Accordingly, the distance between the specimen and the objective lens is preferably changed continuously during the acquisition of at least some of the microscopic frames. The distance between the specimen and the objective lens is thus preferably changed continuously over the course of acquiring the respective microscopic frames, so that at least several of the microscopic frames with a constant distance between the specimen and the objective lens are not excluded, but rather regions of the respective frame are acquired with different distances between the specimen and the objective lens. Preferably, the distance between the specimen and the objective lens is continuously changed during the acquisition of all of the microscopic frames.

One particular advantage of the method according to the invention is that the continuous changing of the focus position also makes it possible to acquire the needed microscopic frames at substantially greater speed during the acquisition of at least some of the microscopic frames. The time required in order to provide an image with an extended depth of field according to the abovementioned example from the prior art can thus be reduced from about 44 seconds to about 25 seconds with a specimen height of 10 mm and an image stack of about 60 images. According to the prior art, the distance between the specimen and the objective lens is changed only in periods of time between the microscopic frame acquisition operations, so that this distance is constant over the course of acquiring a single image. Thus, this distance is not changed in a continuous, but rather in a particularly discrete manner. In contrast, this distance or the focus position is continuously changed according to the invention, so that a motor for changing the height of a specimen-carrying specimen stage need not be stopped between the acquisition of the individual frames, for example.

In preferred embodiments of the method according to the invention, the focus position is changed by changing the distance between the specimen and the objective lens of the microscope or by changing the focus position along a spatial extension of the specimen. The focus position is preferably changed, for example, by controlling a microsystem with movable mirrors or by deforming a deformable optical lens of the objective.

In preferred embodiments of the method according to the invention, the step of processing the plurality of microscopic frames so as to form a microscopic image with an extended depth of field beginning after the acquisition of the respective microscopic frames takes place while other microscopic frames are still being acquired. The individual microscopic frames are each already processed after they are acquired and while other microscopic frames are still being acquired. The method step of acquiring the microscopic frames and the method step of processing the microscopic frames to form a microscopic image having an extended depth of field are thus performed simultaneously at least at times, with it being possible for the method step of processing the microscopic frames to form a microscopic image having an extended depth of field to take longer than the method step of acquiring the microscopic frames. This temporally parallel processing of the method steps results in a further reduction of the time needed to provide the microscopic image with extended depth of field. Preferably, each of the microscopic frames is already processed after it is acquired and while the next of the microscopic frames is being acquired.

In especially preferred embodiments of the invention, the focus position is changed at a speed that is varied during and/or between the microscopic frame acquisition operations. The change in speed is defined by an acceleration. Preferably, the speed and/or the acceleration is changed between the acquisition of the respective microscopic frames.

In preferred embodiments of the method according to the invention, the microscopic frames are each analyzed after they are acquired in order to adjust the change in the focus position—e.g., the change in the distance between the specimen and the objective lens—during the acquisition of the next of the microscopic frames. The change in this distance can be described by a speed between the specimen and the objective lens in the z direction. The microscopic frames are thus each analyzed after they are acquired in order to adjust the velocity in the z direction during the acquisition of the subsequent microscopic frames.

In alternatively preferred embodiments of the method according to the invention, a first of the microscopic frames is analyzed after it is acquired in order to adjust the change in the focus position during the acquisition of subsequent microscopic frames. The first microscopic frame is thus analyzed after it is acquired in order to adjust the speed in the z direction during the acquisition of the subsequent microscopic frames.

In alternatively preferred embodiments of the method according to the invention, only one or more portions of the microscopic frames are analyzed after they are acquired in order to adjust the change in the focus position during the acquisition of subsequent microscopic frames. As a preferred alternative, one or more portions of the first microscopic frame are analyzed after they are acquired in order to adjust the change in the focus position during the acquisition of subsequent microscopic frames.

In preferred embodiments of the method according to the invention, the microscopic frames are each analyzed after they are acquired in order to predict the quality of the respective next frames, which enables the change in the focus position—for example, the change in the distance between the specimen and the objective lens, i.e., the speed in the z direction—to be adjusted during the acquisition of the following microscopic frame.

In preferred embodiments of the method according to the invention, at least one of the microscopic frames is analyzed after it is acquired, but preferably at least two of the microscopic frames that follow one another directly or indirectly are analyzed after they are acquired in order to predict a region of the extended depth of field of the respective microscopic frame that follows, which enables the change in the focus position—for example, the change in the distance between the specimen and the lens, i.e., the speed in the z direction—to be adjusted during the acquisition of the following microscopic frame. Additionally or alternatively, a region or the focus position, or a distance from which the microscopic frames are acquired, or a function of the speed, or the acceleration can be predicted or adjusted through the analysis of the at least one microscopic frame. Preferably, two each of the microscopic frames are analyzed after they are acquired, with it not being necessary for these to be directly consecutive, meaning that at least one microscopic frame can be present between them. At least three each of the microscopic frames are preferably analyzed after they are acquired in order to predict or adjust at least one of the cited parameters.

In preferred embodiments of the method according to the invention, the microscopic frames are each analyzed after they are acquired in order to determine a number of the required microscopic frames. The completion of the acquisition of the microscopic frames is thus determined. Machine learning algorithms are preferably used for this purpose. For example, the specimen to be microscoped is detected or classified, and parameters for acquisition are selected such that they are most suitable for the respective specimen or the respective specimen class.

In preferred embodiments of the method according to the invention, the change in the focus position—for example, the change in the distance between the specimen and the objective lens, i.e., the velocity in the z direction—is determined based on the relationships described below. In the following, the speed in the z direction is referred to as S and may be indicated in μm/ms or in l/ms, for example. A time period T is the duration for which the individual microscopic frames are made available. The speed S and the time period T are dependent not only on the particular specimen to be microscoped—particularly on properties of the specimen to be microscoped, such as reflectance and transmittance—but also on the illumination and acquisition parameters. A time period T_{acq} is the time required to directly acquire one single microscopic frame. A parameter m relates to the number of virtual subregions of the continuous movement in the z direction. Also, the parameter m is a function of the rate at which the microscopic images can be acquired with the particular microscope being used. For example, if 200 microscopic images can be recorded per second with the microscope being used, then T_{acq}=5 μs. In addition, the parameter m is a function of a speed in processing the plurality of microscopic frames to form the microscopic image with an extended depth of field. For example, if the individual microscopic frames are each processed immediately after they are acquired and during the acquisition of the next microscopic frames, and a processing time for this is T_{process.i}, so m≥1+T_{process.i}/T_{acq}.

The parameter m can be influenced by other parameters, which are dependent on the hardware and software of the microscope, on the specimen, and/or on the operation of the microscope. This is described by the following formula:

$$m = 1 + \frac{{T}_{hw . delay}}{{T}_{acq}} + \frac{{T}_{sw . delay}}{{T}_{acq}} + \frac{{T}_{alogorithm . delay}}{{T}_{acq}} + \frac{{T}_{sample . delay}}{{T}_{acq}} + \frac{{T}_{user . delay}}{{T}_{acq}} + \frac{{T}_{abitr . delay}}{{T}_{acq}}$$

In this formula, T_{hw.delay} stands for the time delay caused by the hardware of the microscope. In this formula, T_{sw.delay} stands for the time delay caused by the software of the microscope. In this formula, T_{algorithm.delay} stands for the time delay caused by the processing algorithms used. In this formula, T_{sample.delay} stands for the time delay associated with the specimen to be microscoped, such as a transformation, change of color, change of polarization, evaporation, or growth. In this formula, T_{user.delay} represents the time delay caused by the operator of the microscope, for example through user interaction, presets, or delays as a result of an experiment. In this formula, T_{arbitr.delay} stands for other possible time delays. Accordingly, this formula can be expressed in a general form as follows:

$$m = 1 + {\sum }_{i}^{all parameters} \frac{{T}_{delay . i}}{{T}_{acq}}$$

Inasmuch as the time delay is caused only by the hardware of the microscope and by the processing algorithms used, the time T can be simplified as follows:

T=T_{acq}+T_{hw.delay}+T_{algorithm.delay}.

The following relationship is preferably used:

T=T_{acq}·m

Another parameter n represents a quality parameter defined by the number of virtual subregions of the continuous movement in the z direction. In addition, the parameter n is a function of the microscopic field of view of the specimen, which means that the parameter n is also dependent on the magnification factor of the objective lens, the predefined amount of change in the distance between the specimen and the objective lens, and the desired accuracy Δz in the z direction. If the parameter n is set lower, different heights of the specimen appear flatter in the resulting microscopic image with an extended depth of field. If the parameter n is set higher, the acquisition of each of the microscopic frames takes longer.

Another parameter DoF represents a depth of field and is dependent on the objective lens and possibly on a selected zoom setting, as well as on a numerical aperture NA of the microscope. DoF=λ/(NA²) applies, where λ is a wavelength of the light used in the acquisition.

The following relationship is preferably used:

$$S = \frac{1}{n} \cdot \frac{DoF}{{T}_{acq}}$$

Another parameter stepZ describes a step size in the z direction when displaying the height.

The following relationships are preferably used:

stepZ=S·T

ΔZ=S·T_{acq}

Preferably, a graphical user interface is used by an operator to enter one or more of the parameters. The graphical user interface preferably includes options for setting the speed, the quality, the acquisition rate and/or the acquisition quality.

Some of the above parameters can also be defined in another way; for example, dimensioned or dimensionless, such as stepZ and Δz. The dimensionless parameter n or 1/n or 100·1/n, for example, can also be used. Preferably, the parameters are re-determined on request by metadata of an experiment. As a preferred alternative, the parameters are recalculated and specified on request by metadata of an experiment. The parameters can be preferably selected from among various settings, for example in imaging software.

The microscope according to the invention is digital and comprises an objective lens for the enlarged optical imaging of a specimen on an image plane. The objective lens comprises optical components for enlarged optical imaging of the specimen on the image plane. The optical components are particularly instantiated by optical lenses and optionally also by one or more mirrors, shutters, and filters.

The microscope further comprises an image sensor for converting the image reflected directly or indirectly on the image sensor by the objective lens into an electrical signal.

The microscope according to the invention comprises at least one actuator for changing a focus position of the microscope. In simple embodiments, the actuator is preferably designed to change a distance between a specimen and the objective lens. For this purpose, the actuator preferably comprises an electric motor for moving a specimen stage carrying the specimen or for moving the objective lens. The actuator is preferably designed to change a focal length of the objective lens. The actuator is preferably used to actuate an active optical element with which the focus can be adjusted. Especially preferably, the actuator of the active optical element is a microsystem for mechanically moving micromirrors and/or microlenses. The micromirrors preferably form a lens, particularly a Fresnel lens. By changing the position of the micromirrors, the focal length of the Fresnel lens can be changed very quickly. This quick changing of the focal length enables the focus position to be adjusted very quickly. As a preferred alternative, the actuator is designed to deform a deformable optical lens.

The microscope according to the invention further comprises a control and image processing unit, which serves the purpose of controlling the actuator and processing microscopic frames. The control and image processing unit is configured to carry out the method according to the invention. The control and image processing unit is preferably configured to carry out one of the described preferred embodiments of the method according to the invention. Moreover, the microscope according to the invention preferably also has features that are specified in connection with the method according to the invention and its preferred embodiments.

The control and image processing unit preferably comprises one or more modules for carrying out machine vision algorithms, particularly machine learning algorithms, for evaluating contrasts and/or using wavelets.

### BRIEF DESCRIPTION OF THE DRAWINGS

Additional details and developments of the invention follow from the following description of preferred exemplary embodiments of the invention with reference to the drawing and the tables below. In the drawings:

FIG. 1 shows three diagrams of a speed while changing a distance between a specimen and an objective lens;

FIG. 2 shows an illustration of images from a plurality of focus positions according to the prior art;

FIG. 3 shows an illustration of images from a plurality of focus positions according to a preferred embodiment of a method according to the invention;

FIG. 4 shows a graphical user interface for carrying out a preferred embodiment of the method according to the invention;

FIG. 5 shows the graphical user interface shown in FIG. 4 with a selected setting;

FIG. 6 shows the graphical user interface shown in FIG. 4 with another selected setting;

FIG. 7 shows a modified embodiment of the graphical user interface shown in FIG. 4;

FIG. 8 shows the graphical user interface shown in FIG. 7 with a selected setting; and

FIG. 9 shows the graphical user interface shown in FIG. 7 with another selected setting.

### DETAILED DESCRIPTION

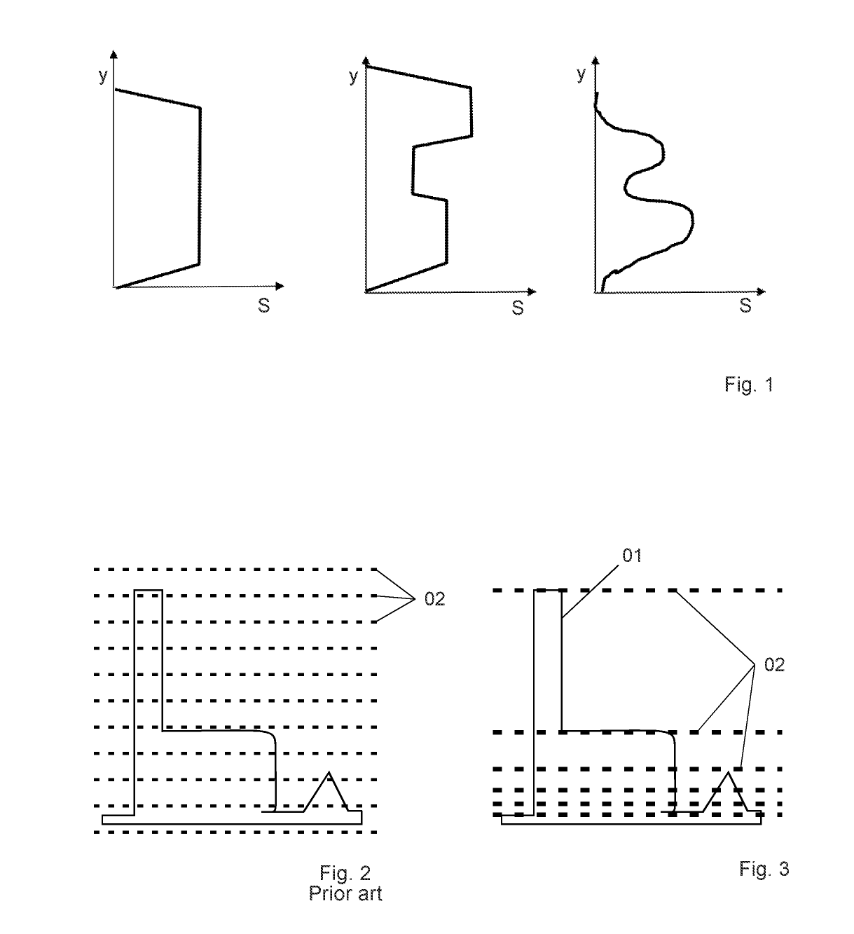

FIG. 1 shows three diagrams of a quantitative relationship between a height z along a specimen to be microscoped and a speed S when changing a distance between the specimen and an objective lens of a microscope used for the microscopy. According to the invention, this distance is continuously changed during the acquisition of microscopic frames, which is already evident in the diagrams given that the speed S is generally greater than zero over the entire process. The left portion of FIG. 1 shows the diagram for a preferred embodiment in which the speed S initially increases linearly and is then constant, after which it finally decreases linearly again. The middle portion of FIG. 1 shows the diagram for an additional preferred embodiment in which the speed S initially increases linearly and is then constant, with a linear decrease and an additional linear increase in the speed S occurring in the meantime, whereupon the speed S finally decreases linearly again. The right portion of FIG. 1 shows the diagram for an additional preferred embodiment in which the speed S increases and decreases according to a higher-order function, thereby avoiding abrupt changes in speed.

FIG. 2 shows an illustration of images from a plurality of focus positions according to the prior art. A plurality of microscopic frames of an exemplary specimen 01 having a plurality of equidistant focus positions 02 are acquired, with the focus positions 02 being illustrated by dashed lines. The acquired microscopic frames of the specimen 01 can be used to produce, by calculation, an image with an extended depth of field, for example.

FIG. 3 shows an illustration of images from a plurality of focus positions according to a preferred embodiment of the method according to the invention. The focus positions 02 are not equidistant here, but are changed at variable speed and/or with variable acceleration while taking the respective microscopic frames of the specimen 01 that have already been acquired into account. In order to illustrate that, according to the invention, the focus positions (02) are changed continuously during the acquisition of the microscopic frames at a variable speed or with variable acceleration, the dashed lines are depicted more broadly compared to FIG. 2.

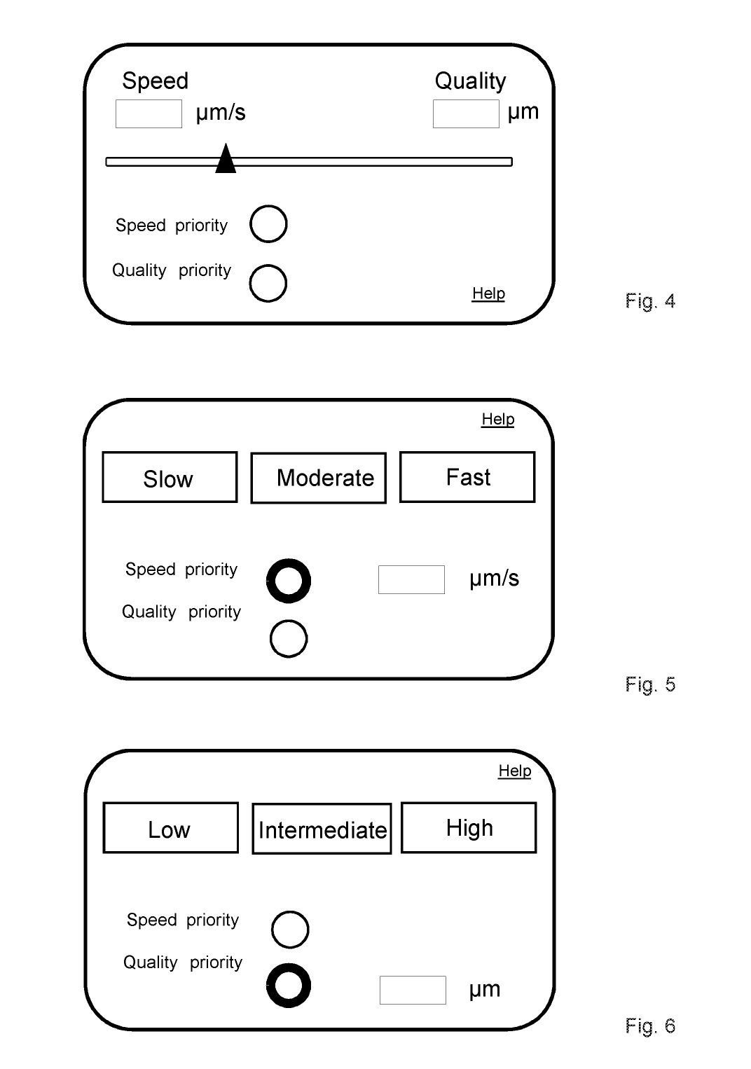

FIG. 4 shows a graphical user interface for carrying out a preferred embodiment of the method according to the invention. The graphical user interface enables the specification of a speed in μs/s of the change in the focus position and/or of an acquisition quality in μm. Alternatively, a slide actuator can be used to balance between these two parameters. The graphical user interface also includes an option to prioritize speed and an alternative option to prioritize quality. In addition, the graphical user interface includes a help function.

FIG. 5 shows the graphical user interface shown in FIG. 4 with the setting to prioritize speed selected. The graphical user interface now enables a selection to be made between slow speed, moderate speed, and fast speed. Alternatively, the speed can be inputted in μs/s.

FIG. 6 shows the graphical user interface shown in FIG. 4 with the setting to prioritize acquisition quality selected. The graphical user interface now enables a selection to be made between low acquisition quality, intermediate acquisition quality, and high acquisition quality. Alternatively, the acquisition quality can be inputted in μm.

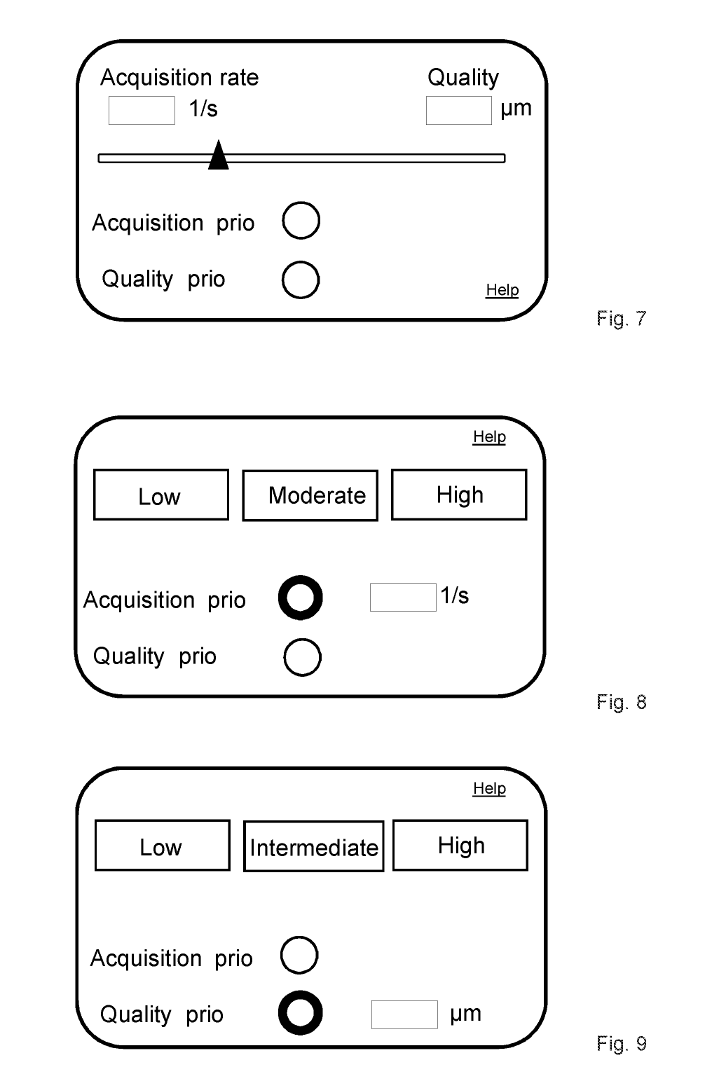

FIG. 7 shows a modified embodiment of the graphical user interface shown in FIG. 4. Instead of the speed in μs/s, an acquisition rate of the microscopic frames to be acquired can be inputted in 1/s. The acquisition rate can be prioritized accordingly.

FIG. 8 shows the graphical user interface shown in FIG. 7 with the setting to prioritize acquisition rate selected. The graphical user interface now enables a selection to be made between low acquisition rate, intermediate acquisition rate, and high acquisition rate. Alternatively, the speed can be inputted in 1/s.

FIG. 9 shows the graphical user interface shown in FIG. 7 with the setting to prioritize acquisition quality selected. The graphical user interface now enables a selection to be made between low acquisition quality, moderate acquisition quality, and high acquisition quality. Alternatively, the acquisition quality can be inputted in μm.

Examples of the prioritization of the speed S and of the prioritization of a quality Q of a microscopic image to be generated with an extended depth of field are shown in table 1 below.

A time period T is the duration for which the individual microscopic frames are made available. A parameter m relates to the number of virtual subregions of the continuous movement in the z direction and represents a function of the rate at which the microscopic images can be acquired with the respective microscope that is being used. A time period T_{acq} is the time required to directly acquire one single microscopic frame. T=T_{acq}·m applies.

Another parameter is a depth of field DoF. DoF=λ/(NA²) applies, where λ is a wavelength of the light used in the acquisition. Another parameter n represents a quality parameter defined by the number of virtual subregions of the continuous movement in the z direction. The following applies:

S=(1/n)·(DoF/T_acq)

Table 1 below shows clearly that the parameters n and m can be selected so as to prioritize the speed or the quality.

TABLE 1

| | Speed priority | Quality priority | S/Q priority |
|---|---|---|---|
| Parameter | mode S | mode Q | (Example) |
| m | 3 | 3 | 3 |
| n | 3 | 10 | 6 |

Table 2 below lists examples of parameters for carrying out a first embodiment of the method according to the invention. A first group of parameters represents settings on the microscope being used to carry out the method according to the invention. The objective lens and its nominal numerical aperture NA are indicated in the first column. A zoom factor is indicated in the second column. A total magnification factor is indicated in the third column. An effective linear numerical aperture NA is indicated in the fourth column. A depth of field DoF that can be theoretically achieved with the microscope is indicated in microns in the fifth column. Another parameter of the first group is a wavelength λ of the captured light, which is 0.5 μm for all examples in table 1. A second set of parameters relates to the algorithms used to process the acquired microscopic frames in order to produce a microscopic image with an extended depth of field. These include the parameters m, n, T_{acq}, and T described above. The parameter m is equal to 1 for all examples in table 1. The parameter n is equal to 1 for all examples in table 1. The parameter T_{acq} is equal to 1 ms for all examples in table 1. The parameter T is also equal to 1 ms for all examples in table 1. In the sixth column, the speed S is indicated in μm/ms. A parameter stepZ, which describes a step size in the z direction when displaying the height, is indicated in μm in the seventh column. A third group of parameters represents quality parameters. A parameter dz, which indicates the resolution in the z direction that is achieved in the generated microscopic image with an extended depth of field, is indicated in μm in the eighth column. The parameter dz pertaining to the depth of field DoF is given in % in the ninth column.

The first embodiment described by the parameters in table 2 results in poor quality of the microscopic image with an extended depth of field to be produced.

TABLE 2

| | | | | | | | Quality | |
|---|---|---|---|---|---|---|---|---|
| Microscope settings | | | | | Algorithm | | parameters | |
| Objective | | | | | parameters | | | dz |
| lens/ | | | NA | DoF | S | stepZ | dz | % |
| nom. NA | Zoom | Enlarg. | eff. | μm | μm/ms | μm | μm | DoF |
| 0.5x/0.03 | 0.5 | 11 | 0.01 | 5000 | 5000 | 5000 | 5000 | 100 |
| | 1 | 21 | 0.012 | 3472 | 3472 | 3472 | 3472 | 100 |
| | 2 | 42 | 0.017 | 1730 | 1730 | 1730 | 1730 | 100 |
| | 3 | 63 | 0.021 | 1134 | 1134 | 1134 | 1134 | 100 |
| | 4 | 84 | 0.026 | 740 | 740 | 740 | 740 | 100 |
| | 5 | 105 | 0.03 | 556 | 556 | 556 | 556 | 100 |
| 1.6x/0.1 | 0.5 | 34 | 0.03 | 556 | 556 | 556 | 556 | 100 |
| | 1 | 67 | 0.038 | 346 | 346 | 346 | 346 | 100 |
| | 2 | 134 | 0.053 | 178 | 178 | 178 | 178 | 100 |
| | 3 | 202 | 0.069 | 105 | 105 | 105 | 105 | 100 |
| | 4 | 269 | 0.084 | 71 | 71 | 71 | 71 | 100 |
| | 5 | 336 | 0.1 | 50 | 50 | 50 | 50 | 100 |
| 5x/0.3 | 0.5 | 105 | 0.1 | 50 | 50 | 50 | 50 | 100 |
| | 1 | 210 | 0.122 | 34 | 34 | 34 | 34 | 100 |
| | 2 | 420 | 0.167 | 18 | 18 | 18 | 18 | 100 |
| | 3 | 630 | 0.211 | 11 | 11 | 11 | 11 | 100 |
| | 4 | 840 | 0.256 | 8 | 8 | 8 | 8 | 100 |
| | 5 | 1050 | 0.3 | 6 | 6 | 6 | 6 | 100 |

Table 3 below lists examples of parameters for carrying out a second embodiment of the method according to the invention. This second embodiment differs from the first embodiment described by the parameters in table 2 in that the parameter T_{acq}=10 ms and the parameter T=10 ms. The parameters A, m, and n are unchanged from the first embodiment. The higher parameter T_{acq} results in a lower speed S.

TABLE 3

| | | | | | | | Quality | |
|---|---|---|---|---|---|---|---|---|
| Microscope settings | | | | | Algorithm | | parameters | |
| Objective | | | | | parameters | | | Dz |
| lens/ | | | NA | DoF | S | stepZ | dz | % |
| nom. NA | Zoom | Enlarg. | eff. | μm | μm/ms | μm | μm | DoF |
| 0.5x/0.03 | 0.5 | 11 | 0.01 | 5000 | 500 | 5000 | 5000 | 100 |
| | 1 | 21 | 0.012 | 3472 | 347 | 3472 | 3472 | 100 |
| | 2 | 42 | 0.017 | 1730 | 173 | 1730 | 1730 | 100 |
| | 3 | 63 | 0.021 | 1134 | 113 | 1130 | 1130 | 100 |
| | 4 | 84 | 0.026 | 740 | 74 | 740 | 740 | 100 |
| | 5 | 105 | 0.03 | 556 | 56 | 556 | 556 | 101 |
| 1.6x/0.1 | 0.5 | 34 | 0.03 | 556 | 55.6 | 556 | 556 | 100 |
| | 1 | 67 | 0.038 | 346 | 34.6 | 346 | 346 | 100 |
| | 2 | 134 | 0.053 | 178 | 17.8 | 178 | 178 | 100 |
| | 3 | 202 | 0.069 | 105 | 10.5 | 105 | 105 | 100 |
| | 4 | 269 | 0.084 | 71 | 7.1 | 71 | 71 | 100 |
| | 5 | 336 | 0.1 | 50 | 5 | 50 | 50 | 100 |
| 5x/0.3 | 0.5 | 105 | 0.1 | 50 | 5 | 50 | 50 | 100 |
| | 1 | 210 | 0.122 | 34 | 3.4 | 34 | 34 | 100 |
| | 2 | 420 | 0.167 | 18 | 1.8 | 18 | 18 | 100 |
| | 3 | 630 | 0.211 | 11 | 1.1 | 11 | 11 | 100 |
| | 4 | 840 | 0.256 | 8 | 0.8 | 8 | 8 | 100 |
| | 5 | 1050 | 0.3 | 6 | 0.6 | 6 | 6 | 100 |

Table 4 below lists examples of parameters for carrying out a third embodiment of the method according to the invention. This third embodiment differs from the second embodiment described by the parameters in table 3 in that the parameter n=3. The parameters λ, m, T, and T_{acq} are unchanged from the second embodiment. The higher parameter n results in a lower speed S and in lower parameters stepZ and dz, whereby the resolution in the z direction is increased. The third embodiment described by the parameters in table 4 thus results in enhanced quality of the microscopic image with an extended depth of field to be produced.

TABLE 4

| Microscope settings | | | | | Algorithm | | Quality | |
|---|---|---|---|---|---|---|---|---|
| Objective | | | | | parameters | | parameters | |
| lens/ | | | | | | stepZ | dz | dz |
| nom. NA | Zoom | Enlarg. | NA eff. | DoF μm | S μm/ms | μm | μm | % DoF |
| 0.5x/0.03 | 0.5 | 11 | 0.01 | 5000 | 167 | 1670 | 1670 | 33 |
| | 1 | 21 | 0.012 | 3472 | 116 | 1160 | 1160 | 33 |
| | 2 | 42 | 0.017 | 1730 | 58 | 580 | 580 | 34 |
| | 3 | 63 | 0.021 | 1134 | 38 | 380 | 380 | 34 |
| | 4 | 84 | 0.026 | 740 | 25 | 250 | 250 | 34 |
| | 5 | 105 | 0.03 | 556 | 19 | 190 | 190 | 34 |
| 1.6x/0.1 | 0.5 | 34 | 0.03 | 556 | 18.53 | 185.3 | 185.3 | 33 |
| | 1 | 67 | 0.038 | 346 | 11.53 | 115.3 | 115.3 | 33 |
| | 2 | 134 | 0.053 | 178 | 5.93 | 59.3 | 59.3 | 33 |
| | 3 | 202 | 0.069 | 105 | 3.5 | 35 | 35 | 33 |
| | 4 | 269 | 0.084 | 71 | 2.37 | 23.7 | 23.7 | 33 |
| | 5 | 336 | 0.1 | 50 | 1.67 | 16.7 | 16.7 | 33 |
| 5x/0.3 | 0.5 | 105 | 0.1 | 50 | 1.667 | 16.67 | 16.67 | 33 |
| | 1 | 210 | 0.122 | 34 | 1.133 | 11.33 | 11.33 | 33 |
| | 2 | 420 | 0.167 | 18 | 0.6 | 6 | 6 | 33 |
| | 3 | 630 | 0.211 | 11 | 0.367 | 3.67 | 3.67 | 33 |
| | 4 | 840 | 0.256 | 8 | 0.267 | 2.67 | 2.67 | 33 |
| | 5 | 1050 | 0.3 | 6 | 0.2 | 2 | 2 | 33 |

Table 5 below lists examples of parameters for carrying out a fourth embodiment of the method according to the invention. This fourth embodiment differs from the third embodiment described by the parameters in table 4 in that the parameter m=3 and the parameter T=30 ms. The parameters λ, n, and T_{acq} are unchanged from the third embodiment. The higher parameter m results in an unchanged speed S and in a higher parameter stepZ compared to the third embodiment described by the parameters in table 4, while the parameter dz is unchanged, so that the resolution in the z direction is unchanged. The fourth embodiment described by the parameters in table 5 also results in enhanced quality of the microscopic image with an extended depth of field to be produced.

TABLE 5

| Microscope settings | | | | | Algorithm | | Quality | |
|---|---|---|---|---|---|---|---|---|
| Objective | | | | | parameters | | parameters | |
| lens/ | | | | | | stepZ | dz | dz |
| nom. NA | Zoom | Enlarg. | NA eff. | DoF μm | S μm/ms | μm | μm | % DoF |
| 0.5x/0.03 | 0.5 | 11 | 0.01 | 5000 | 167 | 5010 | 1670 | 33 |
| | 1 | 21 | 0.012 | 3472 | 116 | 3480 | 1160 | 33 |
| | 2 | 42 | 0.017 | 1730 | 58 | 1740 | 580 | 34 |
| | 3 | 63 | 0.021 | 1134 | 38 | 1140 | 380 | 34 |
| | 4 | 84 | 0.026 | 740 | 25 | 750 | 250 | 34 |
| | 5 | 105 | 0.03 | 556 | 19 | 570 | 190 | 34 |
| 1.6x/0.1 | 0.5 | 34 | 0.03 | 556 | 18.53 | 555.9 | 185.3 | 33 |
| | 1 | 67 | 0.038 | 346 | 11.53 | 345.9 | 115.3 | 33 |
| | 2 | 134 | 0.053 | 178 | 5.93 | 177.9 | 59.3 | 33 |
| | 3 | 202 | 0.069 | 105 | 3.5 | 105 | 35 | 33 |
| | 4 | 269 | 0.084 | 71 | 2.37 | 71.1 | 23.7 | 33 |
| | 5 | 336 | 0.1 | 50 | 1.67 | 50.1 | 16.7 | 33 |
| 5x/0.3 | 0.5 | 105 | 0.1 | 50 | 1.667 | 50.01 | 16.67 | 33 |
| | 1 | 210 | 0.122 | 34 | 1.133 | 33.99 | 11.33 | 33 |
| | 2 | 420 | 0.167 | 18 | 0.6 | 18 | 6 | 33 |
| | 3 | 630 | 0.211 | 11 | 0.367 | 11.01 | 3.67 | 33 |
| | 4 | 840 | 0.256 | 8 | 0.267 | 8.01 | 2.67 | 33 |
| | 5 | 1050 | 0.3 | 6 | 0.2 | 6 | 2 | 33 |

Table 6 below lists examples of parameters for carrying out a fifth embodiment of the method according to the invention. This fifth embodiment differs from the fourth embodiment described by the parameters in table 5 in that the parameter n=10. The parameters λ, m, T, and T_{acq} are unchanged from the fourth embodiment. The higher parameter n results in a reduced speed S and in higher parameters stepZ and dz, so that the resolution in the z direction is increased once again. The fifth embodiment described by the parameters in table 6 also results in further enhanced quality of the microscopic image with an extended depth of field to be produced, but also in increased time expenditure in carrying out the method according to the invention.

TABLE 6

| | | | | | Algorithm | | Quality | |
|---|---|---|---|---|---|---|---|---|
| Microscope settings | | | | | parameters | | parameters | |
| Objective | | | | DoF | | stepZ | dz | dz |
| lens/nom. NA | Zoom | Enlarg. | NA eff. | μm | S μm/ms | μm | μm | % DoF |
| 0.5x/0.03 | 0.5 | 11 | 0.01 | 5000 | 50 | 1500 | 500 | 10 |
| | 1 | 21 | 0.012 | 3472 | 35 | 1050 | 350 | 10 |
| | 2 | 42 | 0.017 | 1730 | 17 | 510 | 170 | 10 |
| | 3 | 63 | 0.021 | 1134 | 11 | 330 | 110 | 10 |
| | 4 | 84 | 0.026 | 740 | 7 | 210 | 70 | 9 |
| | 5 | 105 | 0.03 | 556 | 6 | 180 | 60 | 11 |
| 1.6x/0.1 | 0.5 | 34 | 0.03 | 556 | 5.56 | 166.8 | 55.6 | 10 |
| | 1 | 67 | 0.038 | 346 | 3.34 | 103.8 | 34.6 | 10 |
| | 2 | 134 | 0.053 | 178 | 1.78 | 53.4 | 17.8 | 10 |
| | 3 | 202 | 0.069 | 105 | 1.05 | 31.5 | 10.5 | 10 |
| | 4 | 269 | 0.084 | 71 | 0.71 | 21.3 | 7.1 | 10 |
| | 5 | 336 | 0.1 | 50 | 0.5 | 15 | 5 | 10 |
| 5x/0.3 | 0.5 | 105 | 0.1 | 50 | 0.5 | 15 | 5 | 10 |
| | 1 | 210 | 0.122 | 34 | 0.34 | 10.2 | 3.4 | 10 |
| | 2 | 420 | 0.167 | 18 | 0.18 | 5.4 | 1.8 | 10 |
| | 3 | 630 | 0.211 | 11 | 0.11 | 3.3 | 1.1 | 10 |
| | 4 | 840 | 0.256 | 8 | 0.08 | 2.4 | 0.8 | 10 |
| | 5 | 1050 | 0.3 | 6 | 0.06 | 1.8 | 0.6 | 10 |

### LIST OF REFERENCE SYMBOLS

01—specimen
02—focus position

1. A method for producing a microscopic image with an extended depth of field with the aid of a microscope, comprising the following steps:
acquiring a plurality of microscopic frames of a specimen from different focus positions; and
processing the plurality of microscopic frames so as to form a microscopic image with an extended depth of field,
wherein a focus position is continuously changed during the acquisition of at least some of the microscopic frames at a variable speed or with variable acceleration.

2. The method as set forth in claim 1, wherein the focus position is changed by changing a distance between the specimen and an objective lens of the microscope or by changing the focus position along a spatial extension of the specimen.

3. The method as set forth in claim 1, wherein the focus position is continuously changed during the acquisition of the plurality of microscopic frames.

4. The method as set forth in claim 1, wherein the step of processing the plurality of microscopic frames so as to form a microscopic image with an extended depth of field begins after the acquisition of the respective microscopic frames takes place while other microscopic frames are still being acquired.

5. The method as set forth in claim 1, wherein the focus position is changed at a speed that is changed during and/or between the microscopic frame acquisition operations, with the change in speed being defined by an acceleration, and with the speed and/or the acceleration being changed between the microscopic frame acquisition operations.

6. The method as set forth in claim 1, wherein the microscopic frames are each analyzed after they are acquired in order to adjust the change in the focus position during the acquisition of the next of the microscopic frames.

7. The method as set forth in claim 1, wherein a first of the microscopic frames is analyzed after it is acquired in order to adjust the change in the focus position during the acquisition of subsequent microscopic frames.

8. The method as set forth in claim 1, wherein at least one of the microscopic frames is analyzed after it is acquired in order to predict a region of the extended depth of field of the respective microscopic frame that follows in order to adjust the change in the focus position during the acquisition of the following microscopic frame.

9. The method as set forth in claim 1, wherein the microscopic frames are each analyzed after they are acquired in order to determine a number of required microscopic frames.

10. A microscope, comprising:
an objective lens for optically imaging a specimen;
at least one actuator for changing a focus position of the microscope; and
a control and image processing unit for controlling the at least one actuator and for processing microscopic frames, wherein the control and image processing unit is configured to carry out a method with the microscope for producing a microscopic image with an extended depth of field including:
acquiring a plurality of microscopic frames of a specimen from different focus positions; and
processing the plurality of microscopic frames so as to form a microscopic image with an extended depth of field,
wherein the focus position is continuously changed during the acquisition of at least some of the microscopic frames at a variable speed or with variable acceleration.

11. The method as set forth in claim 2, wherein the focus position is continuously changed during the acquisition of the plurality of microscopic frames.

12. The method as set forth in claim 2, wherein the step of processing the plurality of microscopic frames so as to form a microscopic image with an extended depth of field begins after the acquisition of the respective microscopic frames takes place while other microscopic frames are still being acquired.

13. The method as set forth in claim 3, wherein the step of processing the plurality of microscopic frames so as to form a microscopic image with an extended depth of field begins after the acquisition of the respective microscopic frames takes place while other microscopic frames are still being acquired.

14. The method as set forth in claim 2, wherein the focus position is changed at a speed that is changed during and/or between the microscopic frame acquisition operations, with the change in speed being defined by an acceleration, and with the speed and/or the acceleration being changed between the microscopic frame acquisition operations.

15. The method as set forth in claim 3, wherein the focus position is changed at a speed that is changed during and/or between the microscopic frame acquisition operations, with the change in speed being defined by an acceleration, and with the speed and/or the acceleration being changed between the microscopic frame acquisition operations.

16. The method as set forth in claim 4, wherein the focus position is changed at a speed that is changed during and/or between the microscopic frame acquisition operations, with the change in speed being defined by an acceleration, and with the speed and/or the acceleration being changed between the microscopic frame acquisition operations.

17. The method as set forth in claim 6, wherein at least one of the microscopic frames is analyzed after it is acquired in order to predict a region of the extended depth of field of the respective microscopic frame that follows in order to adjust the change in the focus position during the acquisition of the following microscopic frame.

18. The method as set forth in claim 7, wherein at least one of the microscopic frames is analyzed after it is acquired in order to predict a region of the extended depth of field of the respective microscopic frame that follows in order to adjust the change in the focus position during the acquisition of the following microscopic frame.

19. The microscope as set forth in claim 10, wherein the at least one actuator further comprises an electric motor for moving a specimen stage or for moving the objective lens.

20. The microscope as set forth in claim 10, wherein the at least one actuator further comprises a microsystem for mechanically moving micromirrors and/or microlenses.
